(19) United States
(12) Patent Application Publication
(10) Pub. No.: US 2007/0109259 A1
(43) Pub. Date: May 17, 2007

(54) Exploring platform for virtual environment

(76) Inventor: Xin Liu, Chongqing City (CN)

Correspondence Address: Raymond Y. Chan, #128, 108 N. Ynez Ave., Monterey Park, CA, 91754, US

(21) Appl. No.: 11/334,890

(22) Filed: Jan. 18, 2006

(30) Foreign Application Priority Data
Nov. 11, 2005 (CN) 200520010294.2

(51) Int. Cl. G09G 5/00

(52) U.S. Cl. 345/156

(57) ABSTRACT

An exploring platform for indicating a position of a user in a virtual environment in a computer includes a supporting base defining a sensing area, a plurality of rotors, and a motion capture system. The rotors are spacedly disposed on the sensing area, wherein each of the rotors has a rotor cavity provided on the sensing area of the supporting base and rotatably disposed at the rotor cavity for stead rotation on the supporting base, wherein when the motion capture system is actuated, a coordinate signal is generated corresponding to a movement of the user.

### BACKGROUND OF THE PRESENT INVENTION

1. Field of Invention

The present invention relates to a platform, and more particularly to a platform with a plurality of rotors and a motion capture system for a user of the present invention to explore a virtual environment within a defined real space.

2. Description of Related Arts

With the advance and popularity of information technology, notably ever-increasing computing speed and the quality of displaying devices, the demand for more realistic simulation of physical movement in a virtual environment is rapidly increasing among various disciplines. For example, in the TV games industry, the availability of more sensitive and well-rounded motion sensing devices have become an important factors in the development of more sophisticated TV games involving 3D motion interpretation as well as wider variety of gaming themes. Seemingly, this development reveals the fact that the era of simply relying hands control of several buttons on a conventional game controller has passed and that a new trend of virtual 3D games involving 3D motion controlling has become the key of future TV games.

Conventionally, the most well-known TV games involve motion sensing of a user who is dancing on a ‘dancing pad’. The ‘dancing pad’ provides a plurality of grids representing different directions wherein the user is required to step on one or more particular grid so as to fulfill some particular motions as require by the ‘dancing game’. Admittedly, this type of ‘dancing pad’ is capable of sensing the position of the user's feet so as to create some special visual effect in the virtual environment based on the information of the user's position as sensed by the motion sensor, i.e. the ‘dancing pad’.

A major disadvantage is that the sensing mechanism of this traditional ‘dancing pad’ or similar motion sensing devices only operates in a discrete manner. In other words, the motion sensing devices may only detect the user's position at some particular discrete points and in between those points; the device simply does not work. As a result, the potential of which this motion sensing device may be utilized in other applications is, at best, remote.

As a matter of fact, the demand for virtual reality games is increasing, yet the traditional games controllers do not really suitable for providing optimal virtual experience. Moreover, new trends of TV games shift from traditional joysticks-controlled type to reality control type, especially those commercial versions of them, such as firefighter games, shooting games, etc.

### SUMMARY OF THE PRESENT INVENTION

A main object of the present invention is to provide an exploring platform for the user to explore a virtual environment within a defined real space.

Another object of the present invention is to provide a an exploring platform comprising a motion capture system for virtual environment, wherein the motion capture system is adapted to detect the user's movement so as to produce a corresponding effect of the user's motion in the virtual environment.

Another object of the present invention is to provide an exploring platform comprising a plurality of rotors arranged in a predetermined manner as an array so as to detect the user's motion in a continuous manner for generating a continuous motion effect within the virtual environment.

Another object of the present invention is to provide an exploring platform comprising a plurality of rotors for detecting the user's displacement within a sensing area, wherein by adjusting a friction of the relevant rotors, the exploring platform is capable of fitting into different virtual environments so as to maximize compatibility of the present invention. In other words, the present invention fits for a wide variety of virtual environments.

Another object of the present invention is to provide an exploring platform comprising a plurality of rotors benefit for the health of the user of the present invention when he/she moving on the exploring platform.

Accordingly, in order to accomplish the above objects, the present invention provides an exploring platform for a user to explore a virtual environment provided by computer within a defined real space, comprising:
a supporting base defining a sensing area for the user standing thereon;
a plurality of rotors operatively provided on the sensing area of the supporting base in array; and
a motion capture system electrically connecting with the computer for detecting a movement of the user on the sensing area of the supporting base.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an exploring platform according to a preferred embodiment of the present invention.

FIG. 2 is a schematic side view of the exploring platform according to the above preferred embodiment of the present invention.

FIG. 3 is a schematic diagram of the exploring platform according to the above preferred embodiment of the present invention.

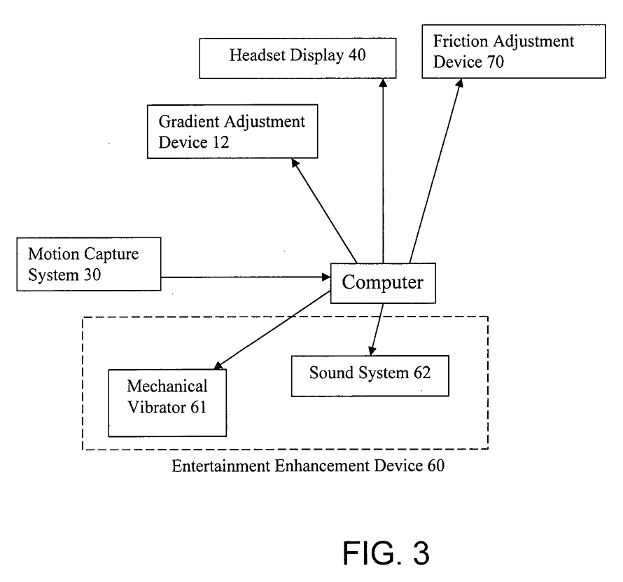

FIG. 4 is an alternative mode of the body supporting frame according to the above preferred embodiment of the present invention.

FIG. 5 is a schematic diagram of the friction adjustment device according to the above preferred embodiment of the present invention.

FIG. 6 is a schematic diagram of the gradient adjustment device according to the above preferred embodiment of the present invention.

FIG. 7 is a schematic partially exploded view of an alternative mode of the motion capture system of the present invention.

### DETAILED DESCRIPTION OF THE PREFERRED EMBODIMENT

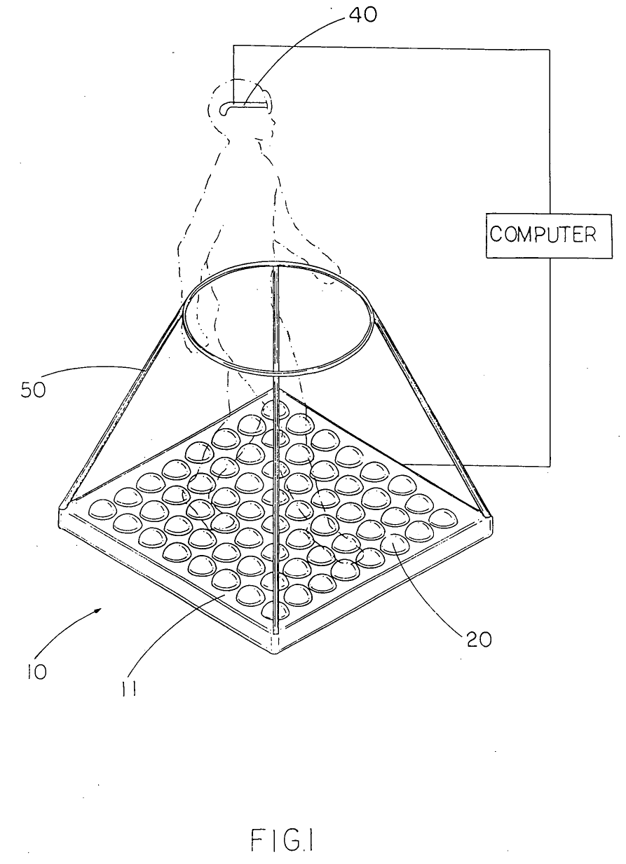

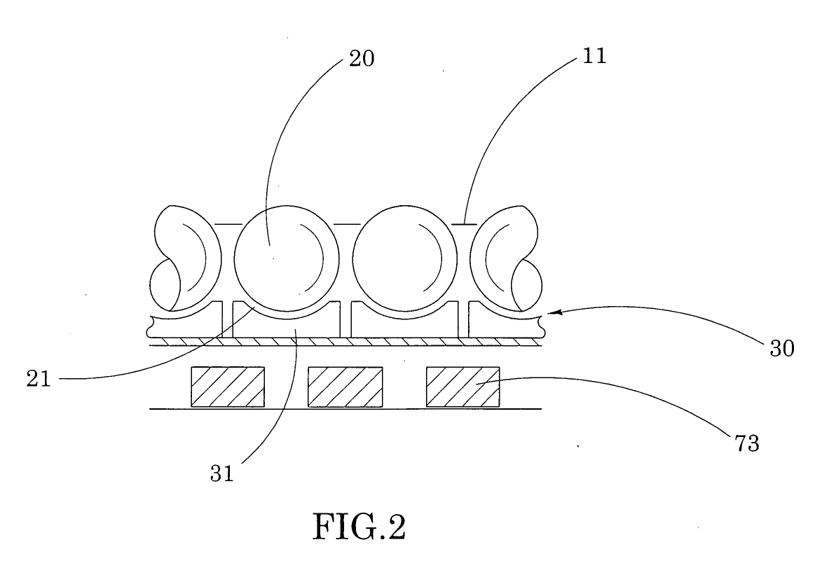

Referring to FIG. 1 and FIG. 2 of the drawings, an exploring platform for the user to explore the virtual environment within a defined real space according to a preferred embodiment of the present invention is illustrated, wherein the exploring platform comprises a supporting base 10 defining a sensing area for a user to stand thereon, a plurality of rotors 20, and a motion capture system 30 electrically connected with the computer.

The plurality of rotors 20 is spacedly disposed on the sensing area of the supporting base 10, wherein each of rotors 20 has a rotor cavity 21 provided on the sensing area of the supporting base 10 and the rotor 20 rotatably disposed at the rotor cavity 21.when the motion capture system is actuated, a coordinate signal is generated corresponding to a movement of the user.

The motion capture system 30 is electrically connected with the computer in such a manner that the coordinate signal is transferred to the computer for producing a corresponding change of position of the user within the virtual environment.

According to the preferred embodiment, the motion capture system 30 comprises a plurality of pressure sensors 31 provided underneath the corresponding rotors 20 on the supporting base 10 in such a manner that when the rotor 20 is stepped on by the user of the present invention, the rotor 20 is slightly and proportionately depressed to transmit a pressure signal on the pressure sensor 31 which produces a corresponding coordinate signal indicating a position of the user's feet at the sensing area. Accordingly, when the user moves within the sensing area, the corresponding pressure sensors 31 are sequentially actuated for producing the corresponding signals at various positions within the sensing area so as to detect a displacement of the user on the supporting base 10. Thus, coordinate signals are then transmitted to the computer for generating a corresponding displacement in the virtual environment.

Referring to FIG. 1 and FIG. 2 of the drawings, when a user is standing on the supporting base 10 so as to contact with a plurality of rotors 20, the corresponding pressure sensors 31 are slightly depressed and transmit the corresponding coordinate signal to the computer. When the user moves on the supporting base 10, subsequent rotors 20 are actuated to reflect new position of the user on the supporting base 10 while the depressed rotors 20 are relieved of any pressure.

It is worth to mention that the plurality of pressure sensors 31 is capable of sensing continuous displacement of the user within the sensing area so that a sliding movement of user may be simulating in the sensing area. Alternatively, the plurality of pressure sensors 31 is also adapted to sense discrete displacement of the user standing on the supporting base 10.

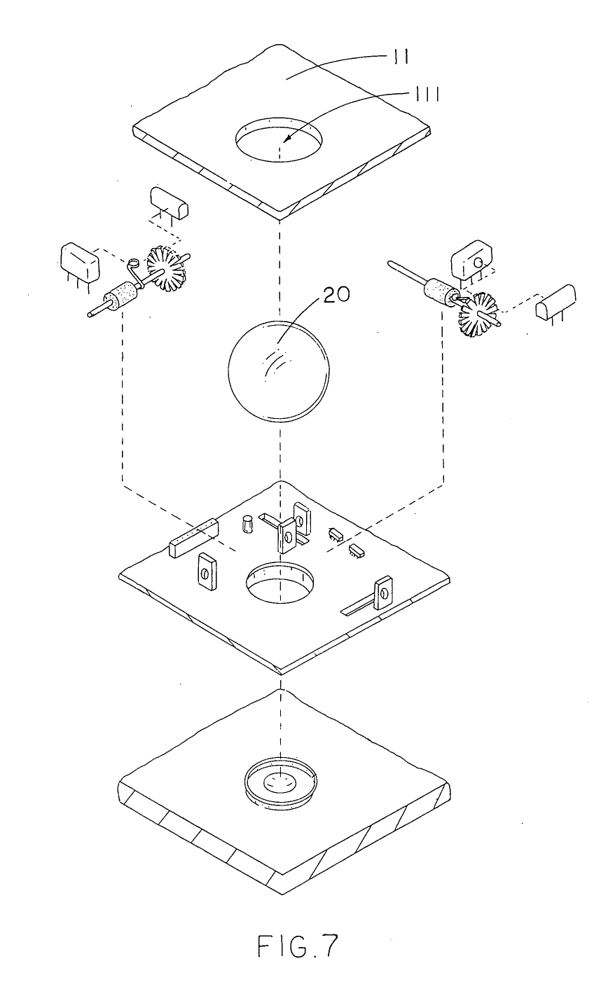

Moreover, referring to FIG. 7 of the drawing, it is worth to mention that the motion capture system could also comprise a plurality of conventional trackball systems (i.e. Trackball Explorer by Microsoft, Turboball by Kensington etc.) work closely with the rotors 20 as an alternative mode of the present motion capture system according to the preferred embodiment for sensing the movement of the user on the supporting base by detecting the rotational movement of the rotors 20.

Obviously, any other motion capture system (i.e. Motion Captor by STT, Gypsy Gyro by Animazoo, Vicon MX40 by Oxford Metrics Limited, EYEtoy by SONY etc.) could be modified as an alternative mode of the present motion capture system according to the preferred embodiment for detecting the movement of the user on the sensing area of the supporting base 10.

Referring to FIG. 1 of the drawings, in order to further enhance the utilization of the present invention, the exploring platform further comprises a headset display 40 electrically connected with the computer, and adapted for being worn on the user's head to cover the eyes thereof so as to display a predetermined virtual image to the user corresponding with a position of the user on the exploring platform. The coordinate signal is first transmitted to the computer. After that, the computer will process the received signal and produce a corresponding video signal which is transmitted to the headset display 40 to simulate the position change within the virtual environment in a graphical representation. In other words, the headset display 40 works closely with the computer and to generate predetermined images of the virtual environment and produce the corresponding changes to the virtual environment when the user moves in the sensing area.

It is worth mentioning that an exploring platform may be used, instead of the headset display 40, in conjunction with a plurality of display screens for simulating a virtual environment with respective to particular computer software/games.

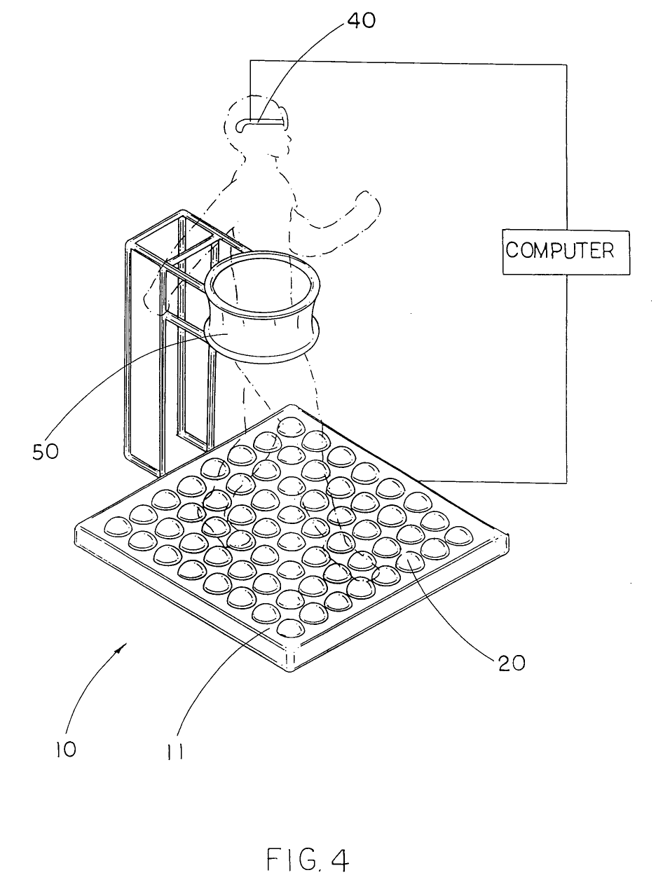

In order to enhance a suitability of the present invention to provide enhanced balance and support to the user of the present invention, the exploring platform further comprises a body supporting frame 50 upwardly extended above the sensing area of the supporting base 10 for providing rigid support to the user when they are accessing to and concentrating on the virtual environment. According to the preferred embodiment of the present invention, the body supporting frame 50 is embodied as a handle frame for a user to hold thereon. Obviously, the body supporting frame 50 may also be embodied for holding other parts of the body, such as the waist portion of the user of the present invention, as shown in FIG. 4 of the drawings.

As a result, when the user has accessed to the virtual environment through a computer display or the headset display 40, he/she may keep his/her best balance by holding into the body supporting frame 50 surrounding him/her. Rigid support may be provided at different height along the body supporting frame 50 so that the present invention suits for users of differing ages.

Referring to FIG. 2 and FIG. 7 of the drawings, the supporting base 10 further has a top standing cover 11, wherein the top standing cover 11 has a plurality of through securing holes 111 formed thereon for allowing a top portion of the respective rotors 20 to be protruded through the respective securing holes 111 in a rotatably movable manner. Thus, the user is able to be supported on the top standing cover 11 while moving within the sensing area.

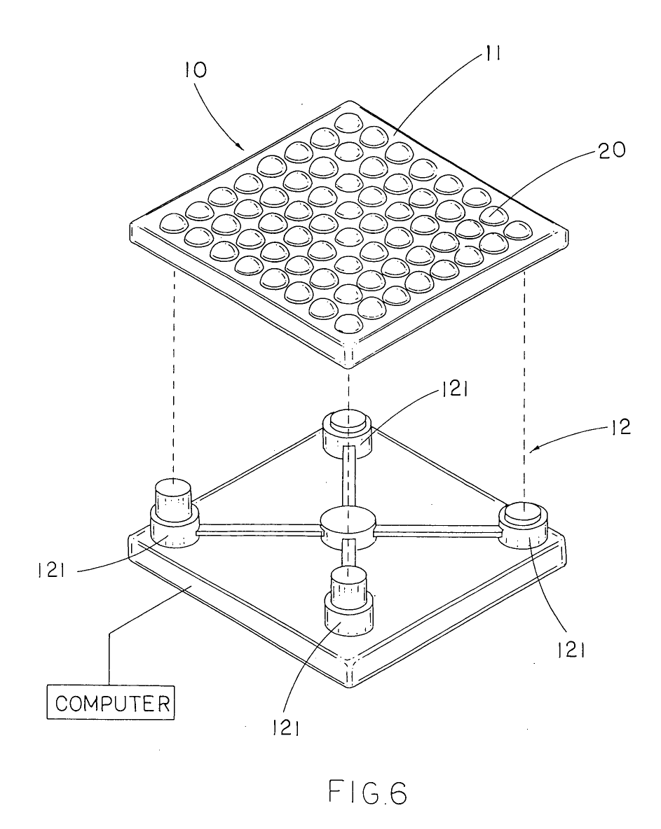

Moreover, referring to FIG. 6 of the drawing, the exploring platform further comprises a gradient adjustment device 12. The gradient adjustment device 12 is adapted to support the supporting base 10 thereon, and adjustably create an inclined angle with the floor surface so as to create a gradient of the sensing area with respective to horizontal. In such a case, the supporting base 10 is inclindly supported to form a gradient for simulating a gradient slope in the virtual environment. Accordingly, the gradient adjustment device 12 may be downwardly inclined to simulate a down-slope surface in the virtual environment. Alternatively, the gradient adjustment device 12 may be upwardly inclined to simulate an uphill walking surface in the virtual environment.

Referring to FIG. 6 of the drawings, it is worth mentioning that the gradient adjustment device 12 is preferably powered by a plurality of lifting devices 121, such as a conventional hydraulic lifting unit operatively communicated with the gradient adjustment device 12, provided underneath the supporting base 10 for adjustably lifting the supporting base 10 at an inclined angle.

It is worth mentioning that in order to further enhance the features of the present invention, the exploring platform can further comprise an entertainment enhancement device 60 arranged to electrically connect with the computer, and comprises means for generating vibration at the supporting base 10 for simulating vibrating walking surface in the virtual environment. According to the preferred embodiment, the means for generating vibration is embodied as a typical mechanical vibrator 61 powered by a motor mounted in the supporting base 10 for generating vibration thereof. The typical mechanical vibrator 61 is electrically connected with the computer which is adapted to provide a digital vibration signal corresponding with the vibrating virtual environment.

Moreover, the entertainment enhancement device 60 may further comprise a sound system 62 provided on the supporting base 10 or the headset display 40 for delivering sound effect corresponding with specific scenarios within the virtual environment. According to the preferred embodiment, the sound system 62 is embodied as several speakers adapted to deliver sound during operation of the exploring platform of the present invention. As a result, the entertainment enhancement device 60 may, according to specific situation within the virtual environment, such as walking down-slop or uphill or running, produce special sound effect in order to enhance entertainment effect of the user of the present invention. The sound system 62 is electrically connected with the computer which, in coordination with the virtual environment, is adapted to produce a digital sound signal to the sound system 62 for generating the sound corresponding with the activities in the virtual environment.

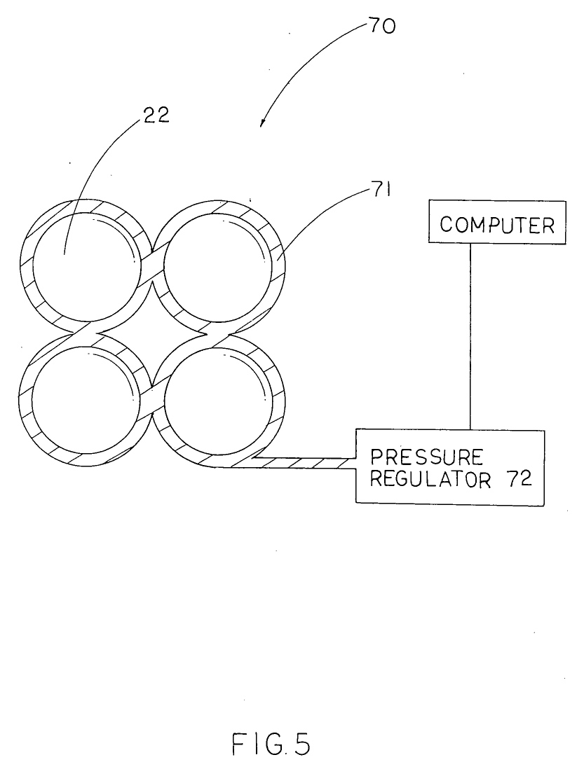

Referring to FIG. 5 of the drawings, an exploring platform further comprises a friction adjustment device 70 supported on the supporting base 10 and is arranged to electrically connect with the computer for adjusting the friction of the rotors 20 in such a manner to simulate different friction for different virtual environment.

Specifically, the friction adjustment device 70 comprises at least one tubular friction adjuster 71, carrying a predetermined amount of fluid at a predetermined pressure, extended between each two rotors 20 to apply a predetermined frictional force to the respective rotors 20 so as to control a friction of rotation thereof, and a pressure regulator 72 connected with the tubular friction adjuster 71 to control a pressure of the fluid carried by the tubular friction adjuster 71, in such a manner that when the pressure of the fluid is increased by the pressure regulator 72, the friction of rotation of the rotor 20 will also be increased. Conversely, when the pressure of the fluid is decreased by the pressure regulator 72, the friction of rotation of the rotors 20 will also be decreased for allowing easier rotation of the rotors 20.

Hence, it is to be appreciated that the pressure regulator 72 is connected with the computer so that when the computer is running a particular software to generate a particular virtual environment, the corresponding friction of the rotors 20 is varied according to the requirement of the relevant virtual application of the computer. For example, if a virtual environment is generated to stimulate forest environment, the computer will send a corresponding signal to the pressure regulator 72 to increase the friction of the rotors 20 so as to simulate a more difficult walking path within the virtual forest.

Moreover, referring to FIG. 2 of the drawing the friction adjustment device 70 of the exploring platform further comprises a plurality of electromagnets 73 underneath the corresponding rotors 20 to control the friction of rotation of rotors 20 in such a manner to simulate different friction for different virtual environment. Obviously, the rotors 20 should contain metallic material to a certain degree. The electromagnets 73 are arranged to electrically connect with the computer for adjusting the friction of rotation of rotors 20 in such a manner that when the electric current passes through the electromagnets 73, the electromagnets 73 become magnetic and attract the rotors 20 on the supporting base 10 and the friction of rotation of the rotors 20 will be increased by the power of attraction of the electromagnets 73. When the electric current is increased by the computer, the friction of rotation of the rotors 20 will be increased. Conversely, when the electric current is decreased by the computer, the friction of rotation of the rotors 20 will also be decreased for allow easier rotation of rotors 20. When the computer is generating a particular virtual environment, the corresponding friction of the rotors 20 is varied according to the requirement of the relevant virtual application of the computer.

From the forgoing descriptions, it can be shown that the above objects have been substantially accomplished. The present invention effectively provides an exploring platform for detecting a movement of a user so as to produce a corresponding effect of the user's motion within the virtual environment.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An exploring platform for a user to explore a virtual environment provided by computer within a defined real space, comprising:
a supporting base defining a sensing area for said user standing thereon;
a plurality of rotors operatively provided on said sensing area of said supporting base in array; and
a motion capture system electrically connecting with said computer for detecting a movement of said user on said sensing area of said supporting base.

2. The exploring platform, as recited in claim 1, wherein said motion capture system comprises a plurality of pressure sensors provided underneath said corresponding rotors on said supporting base in such a manner that when said rotor is stepped on by said user, said rotor is slightly and proportionally depressed to actuate said pressure sensor to produce a corresponding coordinate signal indicating a position of said user at said sensing area.

3. The exploring platform, as recited in claim 2, further comprising a headset display electrically connecting with said computer, and adapted for being worn on said user's head to display a predetermined virtual image, wherein said coordinate signal interpreted by said motion capture system is transmitted to said computer which provides a corresponding video signal to said headset display to simulate said position change of said virtual environment provided by said computer.

4. The exploring platform, as recited in claim 3, wherein said entertainment enhancement device comprise a sound system electrically connected with said computer in such a manner that when said computer delivers a sound signal to said sound system, said sound system delivers sound effect corresponding with said virtual environment.

5. The exploring platform, as recited in claim 3, further comprising a friction adjustment device which comprises at least one tubular friction adjuster carrying a predetermined amount of fluid at a predetermined pressure, extended between each two said rotors to apply a predetermined urging force to said respective rotors so as to control a friction of rotation thereof, and a pressure regulator, adapted for electrically connecting with said computer, communicated with said tubular friction adjuster to control a pressure of said fluid carried by said tubular friction adjuster, such that when said pressure of said fluid is adjusted, said friction of rotation of said rotors is accordingly adjusted.

6. The exploring platform, as recited in claim 4, further comprising a friction adjustment device which comprises at least one tubular friction adjuster carrying a predetermined amount of fluid at a predetermined pressure, extended between each two said rotors to apply a predetermined urging force to said respective rotors so as to control a friction of rotation thereof, and a pressure regulator, adapted for electrically connecting with said computer, communicated with said tubular friction adjuster to control a pressure of said fluid carried by said tubular friction adjuster, such that when said pressure of said fluid is adjusted, said friction of rotation of said rotors is accordingly adjusted.

7. The exploring platform, as recited in claim 3, further comprising a friction adjustment device, which comprises at least one electromagnet underneath said rotors, wherein said electromagnets are electrically connected with said computer for adjusting a frictional force of rotation of said rotors by adjusting a strength of said electric current passing through said electromagnets.

8. The exploring platform, as recited in claim 4, further comprising a friction adjustment device, which comprises at least one electromagnet underneath said rotors, wherein said electromagnets are electrically connected with said computer for adjusting a frictional force of rotation of said rotors by adjusting a strength of said electric current passing through said electromagnets.

9. The exploring platform, as recited in claim 5, wherein said supporting base further comprises a gradient adjustment device adapted to support said rotors thereon, and adjustably create an inclined angle with respect to a floor surface so as to create a gradient of said sensing area for simulating a gradient slope in said virtual environment.

10. The exploring platform, as recited in claim 6, wherein said supporting base further comprises a gradient adjustment device adapted to support said rotors thereon, and adjustably create an inclined angle with respect to a floor surface so as to create a gradient of said sensing area for simulating a gradient slope in said virtual environment.

11. The exploring platform, as recited in claim 7, wherein said supporting base further comprises a gradient adjustment device adapted to support said rotors thereon, and adjustably create an inclined angle with respect to a floor surface so as to create a gradient of said sensing area for simulating a gradient slope in said virtual environment.

12. The exploring platform, as recited in claim 8, wherein said supporting base further comprises a gradient adjustment device adapted to support said rotors thereon, and adjustably create an inclined angle with respect to a floor surface so as to create a gradient of said sensing area for simulating a gradient slope in said virtual environment.

13. The exploring platform, as recited in claim 9, further comprising a body supporting frame extended above said sensing area of said supporting base for providing rigid support to said user displacing on said sensing area.

14. The exploring platform, as recited in claim 10, further comprising a body supporting frame extended above said sensing area of said supporting base for providing rigid support to said user displacing on said sensing area.

15. The exploring platform, as recited in claim 11, further comprising a body supporting frame extended above said sensing area of said supporting base for providing rigid support to said user displacing on said sensing area.

16. The exploring platform, as recited in claim 12, further comprising a body supporting frame extended above said sensing area of said supporting base for providing rigid support to said user displacing on said sensing area.

17. The exploring platform, as recited in claim 15, wherein each of said rotors has a rotor cavity provided on said sensing area of said supporting base, wherein said rotor is rotatably disposed at said rotor cavity for steady rotation on said supporting platform.

18. The exploring platform, as recited in claim 16, wherein each of said rotors has a rotor cavity provided on said sensing area of said supporting base, wherein said rotor is rotatably disposed at said rotor cavity for steady rotation on said supporting platform.

19. The exploring platform, as recited in claim 17, wherein said supporting base further has a top standing cover provided on a top side of said supporting base, wherein said top standing cover has a plurality of through securing holes formed thereon for allowing a top portion of said respective sensor rotor to be protruded from said respective securing holes in a rotatably movable manner to define said array, such that a user is able to stand on said top standing cover for substantially being supported while adapted to move within said sensing area to simulate a displacement within said virtual environment.

20. The exploring platform, as recited in claim 18, wherein said supporting base further has a top standing cover provided on a top side of said supporting base, wherein said top standing cover has a plurality of through securing holes formed thereon for allowing a top portion of said respective sensor rotor to be protruded from said respective securing holes in a rotatably movable manner to define said array, such that a user is able to stand on said top standing cover for substantially being supported while adapted to move within said sensing area to simulate a displacement within said virtual environment.
